(19) United States
(12) Patent Application Publication
(10) Pub. No.: US 2025/0371658 A1
(43) Pub. Date: Dec. 4, 2025

(54) LIGHTWEIGHT CHANGE DETECTION SYSTEM ON LOW-RESOLUTION VIDEO STREAM

(71) Applicant: Intel Corporation, Santa Clara, CA (US)

(72) Inventors: Moran Klein, Ra’anana (IL); Dor Barber, Herzliya (IL); Rony Zatzarinni, Tel Aviv (IL)

(21) Appl. No.: 19/306,360

(22) Filed: Aug. 21, 2025

(51) Int. Cl. G06T 3/4046; G06N 3/0455; G06N 3/0464

(52) U.S. Cl. CPC G06T 3/4046; G06N 3/0455; G06N 3/0464

(57) ABSTRACT

Systems and methods are provided for change detection in low-resolution video streams, which can be used for applications such as high resolution video restoration and processing. The techniques effectively detect changes by leveraging a large receptive field and lightweight computation, which are achieved by working with low-resolution images. In particular, the techniques include extracting features from a change detection model and a semantic segmentation model, and integrating the extracted feature outputs from the models to produce a robust change detection map. A pre-processing phase can be employed to optimize the input for each model, ensuring minimal complexity and enhanced performance. The change detection model can be implemented as a deep neural network, and methods are provided for generating ground truth (GT) data, which semantically guides the change detection neural network to perform change detection inpainting during training.

### TECHNICAL FIELD

This disclosure relates generally to temporal noise reduction, and in particular to change detection for temporal noise reduction.

### BACKGROUND

Temporal noise reduction can be used to decrease noise in video streams. Noisy video image streams can appear jittery. While image portions with static objects can be averaged over time, averaging moving objects can result in a smearing and/or ghosting effect. Thus, one challenge in temporal noise reduction is to distinguish between true motion and noise. Temporal noise reducers can incorporate a classifier that determines whether information can or cannot be averaged. In particular, a temporal noise reduction (TNR) classifier can determine which portions of video images include static pixels that can be averaged for temporal noise reduction, and which portions of video images are dynamic and cannot be averaged.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a high level block diagram of an example change detection system, in accordance with various embodiments.

FIG. 2 is a block diagram of a pre-processing pipeline, in accordance with various embodiments.

FIG. 3 is a block diagram 300 illustrating data fusion of segmentation module output and change detection module output, in accordance with various embodiments.

FIG. 4 is a block diagram of a change detection neural network, in accordance with various embodiments

FIG. 5 illustrates a block diagram of an example change detection ground truth generation pipeline, in accordance with various embodiments.

FIG. 6 illustrates a first process for generating downscaled ground truth data and a second process for generating ground truth data, in accordance with various embodiments.

FIG. 7 is a block diagram illustrating training data noise augmentation, in accordance with various embodiments.

FIG. 8 is a block diagram of a change detection system including an image signal processing (ISP) pipeline, in accordance with various embodiments.

FIG. 9 is a flowchart showing a method for change detection on a low-resolution video stream, in accordance with various embodiments.

FIG. 10 is a block diagram of an example DNN system, in accordance with various embodiments.

FIG. 11 illustrates an example DNN, in accordance with various embodiments.

FIG. 12 is a block diagram of an example computing device, in accordance with various embodiments.

### DETAILED DESCRIPTION

### Overview

An image signal processor (ISP) converts raw sensor data into high-quality image or video through a sequence of hardware blocks, each performing specific operations such as defective pixel correction, denoising, and sharpening. However, these hardware blocks have a restricted receptive field, and thus processing decisions are based on limited local information. Denoising, a core ISP algorithm, determines appropriate noise reduction strategies for each pixel. Denoising distinguishes between two scenarios: pixels that change between frames (dynamic pixels) and static pixels. Dynamic pixels receive spatial denoising, while static pixels receive temporal denoising. Temporal denoising tends to be higher quality denoising. Changes between consecutive frames can be due to movement or illumination changes, occlusions and moving shadow.

Systems and methods are presented herein for change detection in low-resolution video streams. The systems and methods can be used for applications such as high resolution video restoration and processing. The systems and methods effectively detect changes by leveraging a large receptive field and lightweight computation, which are achieved by working with low-resolution images. In particular, the systems and methods include extracting features from both a change detection model and a semantic segmentation model, and a fusion phase that integrates the extracted feature outputs to produce a robust change detection map. A pre-processing phase can be employed to optimize the input for each model, ensuring minimal complexity and enhanced performance. Additionally, systems and methods are provided for generating ground truth (GT) data, which semantically guides the change detection neural network to perform change detection inpainting during training, resulting in superior accuracy and consistency.

Temporal noise reduction is a core feature of a video processing pipeline, where TNR can be used to decrease noise in video streams. In particular, information from consecutive input frames can be used to produce a superior output frame. Temporal noise reducers (TNRs) can incorporate a classifier that determines which portions of video images can be averaged for temporal noise reduction, and which portions of video images cannot be averaged. In particular, TNRs aim to suppress random noise while preserving motion and fine details. A key challenge in temporal noise reduction is distinguishing between true motion and noise, which includes accurate classification of pixels as either static (unchanged across frames) or dynamic (changing due to motion or scene variation).

Correct classification of pixels as static or dynamic is important because incorrect decisions lead to inconsistent denoising and ghost artifacts. Ghost artifacts are image artifacts that occur when temporal denoising creates a semi-transparent trail of previous frames in moving regions. However, accurate change detection is particularly challenging with a limited receptive field for two key reasons: movement in flat regions is difficult to detect due to minimal texture, and subtle changes can be smaller than the sensor noise level. For example, in a change detection map of a talking person, the forehead often appears static because it lacks texture. However, we know the forehead must move with the rest of the head and incorrectly applying temporal denoising in the forehead area of an image will create visible ghosting artifacts. Correct classification is even harder in the presence of both noise and degradation (e.g., blur). While using a larger receptive field can improve accuracy of classification, this results in increased computational power usage as well as other system costs.

Systems and methods are presented herein for increasing classification accuracy using an existing downscaled video stream that is already available in the processing pipeline for other analysis purposes. Processing downscaled imagery offers significant advantages, including providing a larger effective receptive field and reducing computational complexity. However, processing downscaled imagery exacerbates the challenge of detecting small changes for pixel classification purposes. The downscaling process inherently blurs or eliminates subtle changes that are used for accurate video processing decisions. The systems and methods presented herein include a change detection system that combines a segmentation map and a neural network for generating a raw change detection map. These maps can be fused together to produce a robust and temporally consistent change detection map.

In various implementations, the systems and methods presented herein can generate a semantic change detection map, which identifies temporal changes between images while maintaining semantic level detail. In some implementations, the systems and methods presented herein can generate a panoptic change detection map, which identifies temporal changes between images while maintaining both semantic and instance level detail. The output map can be based on the nature of the segmentation map, which can be already available in the image pipeline. The output map can be used to generate consistent and coherent processing decisions within each segment. In various examples, change detection in a camera pipeline context can serve as a pre-processing step for various applications, such as saliency detection and action recognition.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Change Detection System

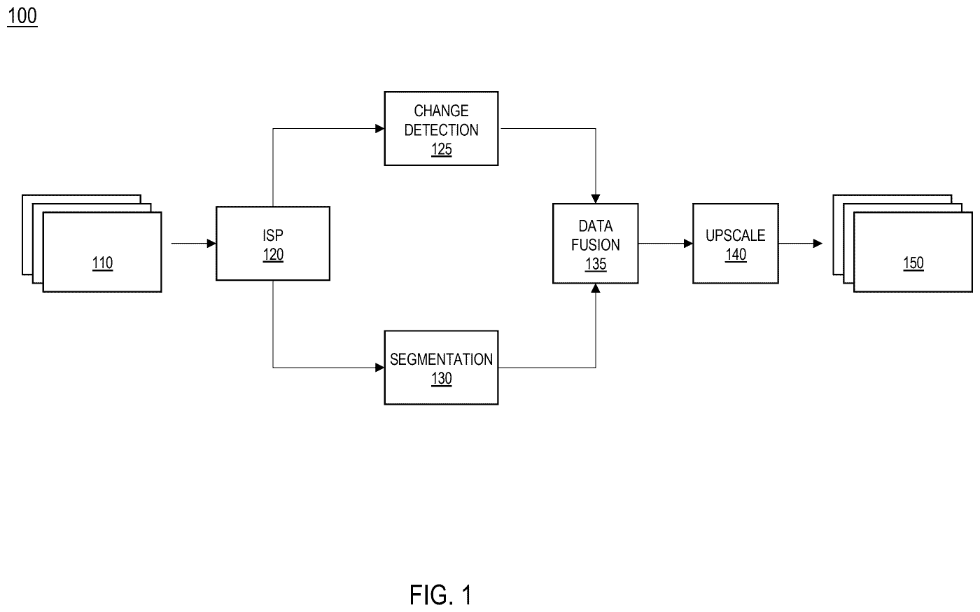

FIG. 1 is a high level block diagram of an example change detection system 100, in accordance with various embodiments. The change detection system 100 integrates a change detection module 125 with a video segmentation framework. In particular, the change detection system 100 includes the change detection module 125, which can be a lightweight convolutional neural network (CNN), a segmentation module 130, and a data fusion module 135.

The input 110 to the change detection system 100 is a video stream, and the input 110 can be a raw video stream. The input 110 is pre-processed by an image signal processor (ISP) 120, which outputs a downscaled RGB video stream based on the input 110. In some examples, the ISP 120 is designed to perform minimal and optimized processing for each of two data paths: a change detection data path and a segmentation data path. The data paths can be parallel data paths. The change detection data path includes the change detection module 125, which outputs a change detection prediction map. The segmentation data path includes the segmentation module 130, which outputs a segmentation prediction map. The change detection prediction map output from the change detection module 125 and the segmentation prediction map output from the segmentation module 130 are input to a data fusion module 135. The data fusion module 135 fuses the change detection prediction map and the segmentation prediction map to generate a fused change detection prediction map, which is input to the upscale module 140. The upscale module upscales the fused change detection prediction map to the original high resolution of the input video stream and outputs the upscaled change detection prediction map 150.

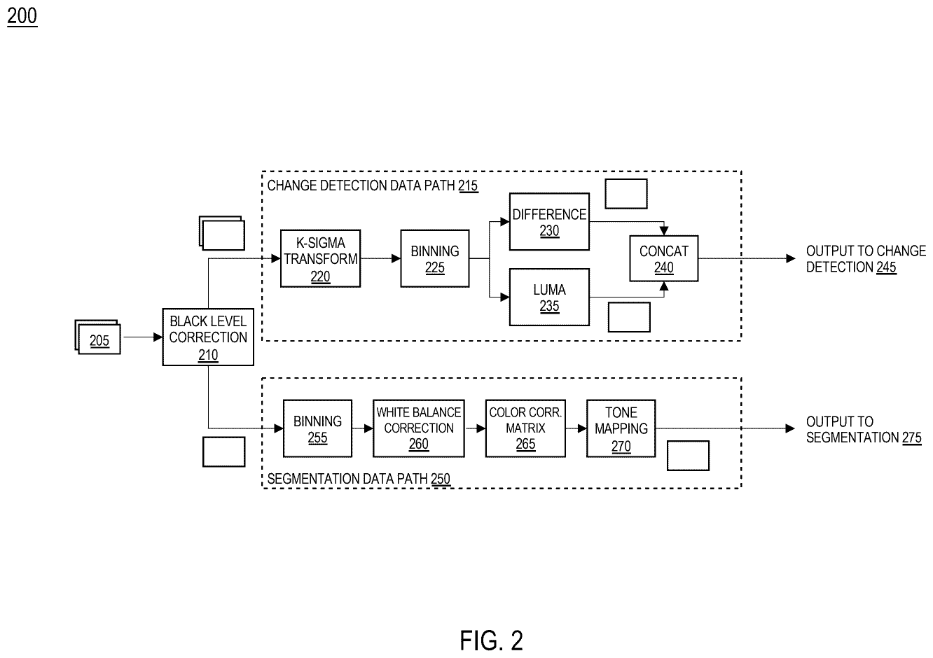

FIG. 2 is a block diagram of a pre-processing pipeline 200, in accordance with various embodiments. In some examples, the block diagram of the pre-processing pipeline 200 represents the ISP 120, and the ISP 120 pre-processes the input 110 using the pre-processing pipeline 200. Pre-processing includes downscaling raw unprocessed images 205 output from an image sensor. In some examples, the raw unprocessed images are Bayer images.

According to various implementations, image pre-processing for change detection is different from image pre-processing for segmentation. For example, change detection can be performed without absolute colors. In contrast, segmentation utilizes colors for segmenting color-related segments such as sky, skin tones and foliage. In another example, change detection utilizes the noise characteristics of the raw video stream since the noise characteristics allow for determination of a reliable noise model that eases training to distinguish between temporal noise and temporal visual change. In contrast, segmentation can be performed without distinguishing between temporal noise and temporal visual change.

The input images 205 to the pre-processing pipeline 200 are received at a black level correction block 210. The black level correction block 210 outputs two consecutive video frames to the change detection data path 215: the current frame (frame n) and the previous frame (frame n−1). The two consecutive video frames are received at a k-sigma transform block 220, where a k-sigma transform is applied. In various examples, by measuring and estimating sensor noise level, a smaller network trained on synthetic sensor specific data can out-perform a larger network trained on general data. Thus, the large noise level variation under different ISO settings can be removed by the k-Sigma Transform block 220, allowing a small network to efficiently handle a wide range of noise levels.

The output from the block 220 is input to a binning block 225, which performs a binning operation. The binning operation includes naive demosaicing and downscaling. The downscaling process reduces the image size of the image frames by grouping pixels into blocks of pixels and averaging the pixel values in each block of pixels. Downscaling results in a low-resolution RGB image that retains the overall structure and content of the original image. The binning operation can downscale the raw image into an RGB image by a constant integer factor which is a multiplication of 2 (e.g., ×2, ×4×8 or ×16).

The output from the binning block 225 is input to a difference block 230 and to a luma block 235. At the difference block 230, the difference between the two consecutive video frames is determined. At the luma block 235, the lumas of each frame are determined. The lumas of each frame are used for semantic cues for the change detection prediction map, as explained in greater detail below. The output from the difference block 230 and the output from the luma block 235 are input to a concatenation block 240, where the frames lumas and the frames difference are concatenated, resulting in an output 245. The output 245 can be a 5-channel input (also referred to herein as the change detection input) to the change detection neural network. In various implementations, the operations in the change detection data path 215 are minimal and linear, and thus the noise characteristics of the images are preserved.

The black level correction block 210 outputs one frame to the segmentation data path 250. The output from the black level correction block 210 is input to a binning block 255, which performs a binning operation. The binning operation includes naive demosaicing and downscaling. The downscaling process reduces the image size of the image frame by grouping pixels into blocks of pixels and averaging the pixel values in each block of pixels. Downscaling results in a low-resolution RGB image that retains the overall structure and content of the original image. The binning operation can downscale the raw image into an RGB image by a constant integer factor which is a multiplication of 2 (e.g., ×2, ×4×8 or ×16).

The output from the binning block 255 is input to a white balance correction block 260, where the image is processed for white balance correction. The output from the white balance correction block 260 is input to a color correction matrix block 265 for color correction. The output from the block 265 is input to a tone mapping block 270. The tone mapping block performs a tone mapping operation, such as a gamma function operation. In various examples, the white balance correction block 260, the color correction matrix block 265, and the tone mapping block 270 adjust the image's global appearance, i.e., the overall brightness, color balance, and color accuracy. The output from the tone mapping block 270 is the output 275 from the segmentation data path 250.

Referring back to FIG. 1, following pre-processing, the change detection output from the ISP 120 (output to change detection 245) is input to the change detection module 125. The input to the change detection module 125 is processed by a change detection model. The change detection model analyzes the difference between two consecutive video frames, identifying areas of change and distinguishing between change that is related to temporal noise and change that is related to temporal visual content. The information provided by the luma block 235 enables the change detection model to relate the local change to the semantic context of the surrounding area which results in a change detection map that is more accurate and uniform, as well as semantically tighter. The output of the change detection model is a low-resolution dense change detection class map that classifies each pixel as stationary (“0”) or non-stationary (“1”). The change detection model is described in greater detail below. The output from the change detection module 125 is input to the data fusion module 135, where it is processed with the output from the segmentation module 130.

Referring again to FIG. 1, following pre-processing, the segmentation output from the ISP 120 (output to segmentation 275) is input to the segmentation module 130. In various examples, the segmentation model can be any selected segmentation framework. The output from the segmentation module 130 can be a segmentation classification map. The output from the segmentation module 130 is input to the data fusion module 135, where it is processed with the output from the change detection module 125.

According to various implementations, the change detection output and the segmentation output are merged into a change detection classification map at the data fusion module 135. In some examples, the change detection output and the segmentation output are merged by thresholding the Intersection of Union (IOU) between the change detection classification map and each segment from the segmentation classification map. In particular, a segment is classified as non-stationary if the segments IOU is greater than a selected threshold. For example, if the threshold is set to be 0.3, a selected segment is non-stationary if 30% of it (area) is classified as changed by the change detection map. The data fusion module 135 can also perform decision temporal processing, which results in a smoother and more consistent fused classification map.

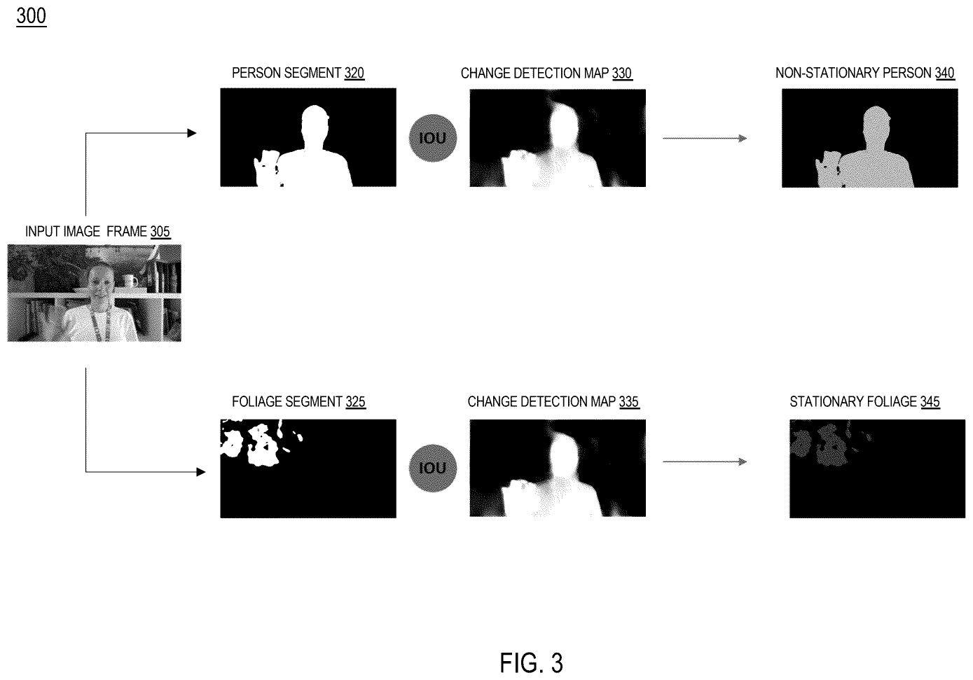

FIG. 3 is a block diagram 300 illustrating data fusion of segmentation module output and change detection module output, in accordance with various embodiments. The person segment map 320 and the foliage segment map 325 can be outputs from the segmentation module 130. The change detection maps 330 and 335 are outputs from the change detection module 125. In various examples, the change detection module 125 outputs one change detection map, and the change detection map 330 is the same map as the change detection map 335. As illustrated in FIG. 3, the person segment map 320 is merged with the change detection map 330 by thresholding the IOU between the person segment map 320 and the change detection map 330, and the output is a non-stationary person map 340. In particular, the change detection map 330 indicates that only the person is moving and that the rest of the scene is a static background. Data fusion of the person segment map 320 and the change detection map 330 can include determining the overlay of the person segment map 320 on the change detection map 330. Here, the person segment map 320 and the change detection map 330 overlap significantly, and the fusion of the two maps, the non-stationary person map 340 indicates that portions of the input image identified as the person are classified as non-stationary pixels.

Similarly, the foliage segment map 325 is merged with the change detection map 355 by thresholding the IOU between the foliage segment map 325 and the change detection map 335, and the output is a stationary foliage map 345. In particular, the change detection map 335 indicates that only the person is moving and that the rest of the scene, including the foliage segment, is a static background. Data fusion of the foliage segment map 325 and the change detection map 335 can include determining the overlay of the foliage segment map 325 on the change detection map 335. Here, the foliage segment map 325 and the change detection map 335 have little to no overlap, and the fusion of the two maps, the stationary foliage map 345 indicates that portions of the input image identified as the foliage are classified as stationary pixels.

Referring back to FIG. 1, following data fusion, the output from the data fusion module 135 is upscaled at the upscale module 140. In particular, the change detection map can be upscaled to the size of the high resolution image. In some examples, the change detection map is upscaled through interpolation, which estimates the change detection classes for the additional pixels in the higher resolution output image based on the values of the surrounding pixels in the lower resolution fused classification map output from the data fusion module 135. Interpolation can be achieved through any selected interpolation method, such as nearest neighbor interpolation, bilateral interpolation, and/or guided interpolation. In some examples, nearest neighbor interpolation can be used when the upscaling factor is low, such as equal to or less than ×4. In some examples, bilateral and/or guided interpolation is more advanced and more accurate than nearest neighbor interpolation, and therefore bilateral and/or guided interpolation can be preferable for higher interpolation factors. In other examples, other selected interpolation methods can be used for upscaling the output from the data fusion module 135. In some examples, the output 150 from the upscaling module 140 can be change detection maps that have the same resolution as the input images 110. In some examples, the output 150 from the upscaling module 140 can be change detection maps that have a resolution that is similar to the input images 110. In some examples, the output 150 from the upscaling module 140 can be change detection maps that have a resolution that is similar to a processed version of the input images 110.

### Example Change Detection Module

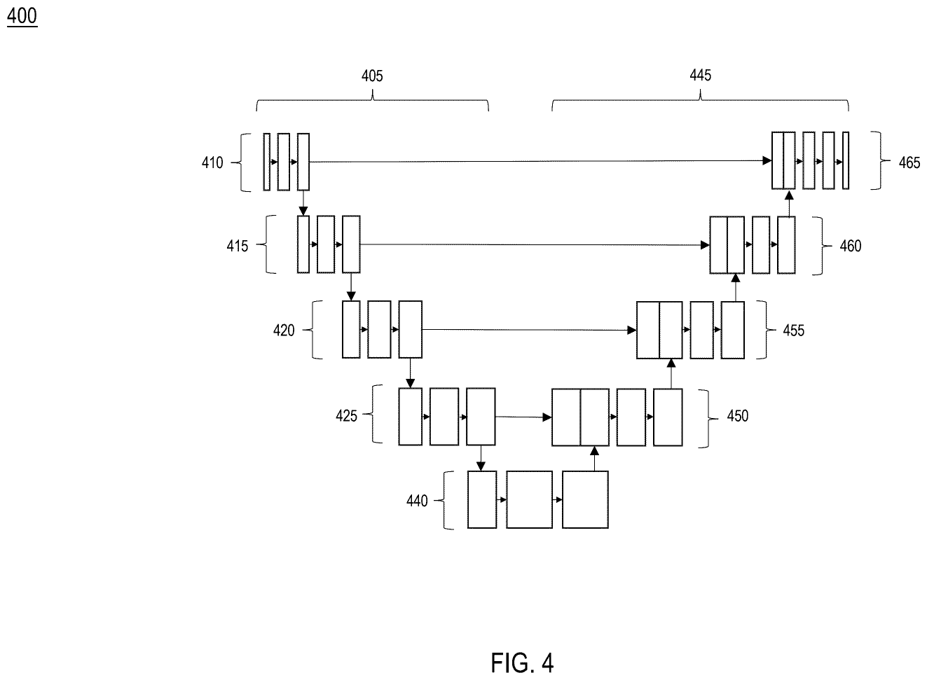

FIG. 4 is a block diagram of a change detection neural network 400, in accordance with various embodiments. The change detection neural network 400 receives low resolution images, for example from the ISP module 120. The change detection neural network 400 model analyzes the image data, for example the image data from two consecutive image frames, and identifies areas of change between the two image frames based on variations in pixel values and semantics. The output is a change detection classification map that provides an estimation of changing vs. static areas in an image frame (e.g., a current image frame vs. a previous image frame).

The change detection neural network 400, as shown in FIG. 4, is a Convolutional Neural Network (CNN), a type of deep learning model. Additionally, the change detection neural network 400 as shown in FIG. 4 has a U-Net shaped architecture, including an encoder 405 and a decoder 445. The input to the change detection neural network 400 can be a downscaled five channel input, such as output 245 from the ISP 120, as described above with respect to FIGS. 1 and 2. The resolution of the input image is M×N×5. In various examples, the larger dimension of the image (height or width) is less than or equal to 512. The aspect ratio of the downscaled image is preserved from the original full-size image.

In the encoder 405 stage, the change detection neural network 400 includes several layers, grouped in the U-Net architecture into first layers 410, second layers 415, third layers 420, and fourth layers 425, each operating on a different scale (i.e., different spatial dimensions) and designed to extract distinct features from the input image. In various examples, the first layers 410, second layers 415, third layers 420, and fourth layers 425 each include multiple layers, including two convolutional layers and one max pooling layer. In particular, the first two layers in each group operate on a larger spatial dimension, applying a series of filters to the image to detect low-level features like edges and textures. In some examples, the first two layers in each group are 3×3 convolution layers. These layers are followed by max pooling layers, which reduce the data's dimensionality while preserving the most important information and increasing the number of channels. In some examples, the max pooling layers are 2×2 max pooling layers. The increase in the number of channels is designed to incorporate semantic knowledge into the change detection estimation process. In some examples, the output from the max pooling layer is received at a next convolutional layer. The output from the max pooling layer can also be connected to a corresponding decoding layer via a skip connect.

The convolution layers and max pooling are repeated four times, in first layers 410, second layers 415, third layers 420, and fourth layers 425, to reach the bottleneck information at the fifth layer 440. In some examples, the fifth layer 440 has the size of M/16×N/16×1024. The fifth layer includes two 3×3 convolutional layers and a 2×2 up-convolution layer, in which a 2×2 up-convolution operator is applied to upscale the feature maps to a high scale. In various examples, the last layer of each scale is a convolutional gated recurrent unit (conv-GRU), which is a type of recurrent neural network (RNN) that uses update and reset gates to control information flow through the network and effectively captures long-term dependencies. In various examples, the conv-GRU enables the change detection neural network 400 to output temporally consistent and robust predictions.

In the decoder 445 stage, the change detection neural network 400 includes several layers, grouped in the U-Net architecture into fourth layers 450, third layers 455, second layers 460, and first layers 465, each operating on a different scale. At each stage, a 2×2 up-convolution operator is applied to upscale the feature maps to a higher scale. A concatenation operator then combines the matching scale from the corresponding encoder layer, via the skip connect. This is followed by several convolution layers to process the upscaled and concatenated features together. These operations are repeated in the decoder stage until the spatial resolution of the input image is restored. The change detection neural network's final layer is a 1×1 convolution layer, which serves as a fully connected layer per pixel, combining the features extracted by the previous layers to make the final change detection/change classification predictions.

In particular, the change detection neural network 400 classifies each pixel in the low resolution image as “stationary” or “non-stationary”. The classification provides a guide for how each pixel is processed in subsequent processing stages. In various embodiments, the change detection neural network 400 outputs a low resolution change detection map based on the predicted classifications of each pixel.

In various implementations, the change detection neural network 400 can be trained using a combined loss function that includes both soft Dice Loss and Binary Cross-Entropy (BCE) loss. The combined loss function is a methodology that can be used in image segmentation tasks. The BCE loss quantifies the pixel-wise agreement between the predicted change detection maps and the ground truth. In some examples, the soft Dice loss is used to achieve precise boundary localization.

### Example Systems and Methods for Training a Change Detection Model

The training dataset for the change detection estimation model includes a large collection of high quality, low-noise raw video streams at different frame rates (i.e., different numbers of frames-per-second (FPS)). The video streams are diverse and representative of a variety of scenes, dynamics, objects, and lighting conditions that the model is likely to encounter in real-world applications. Additionally, the raw video streams can be supplemented with selections from publicly available raw video streams datasets.

According to various implementations, to generate the ground truth (GT) data, images are converted from RAW image formats to RGB image formats using an ISP. The ISP can include receptive field denoising.

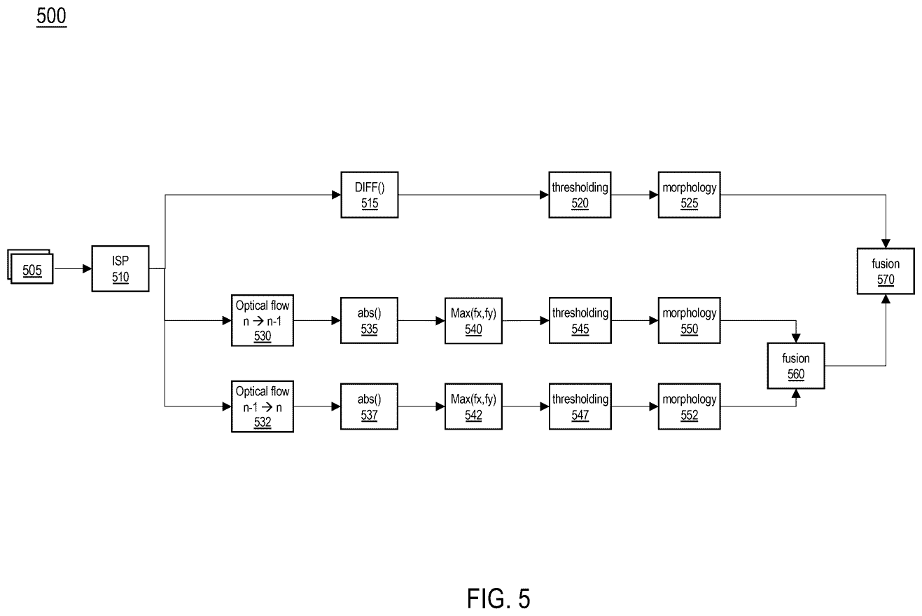

FIG. 5 illustrates a block diagram of an example change detection ground truth generation pipeline 500, in accordance with various embodiments. Raw images 505 are input to an ISP 510. The ISP can convert the input images to RGB images. The RGB images can be processed using two different techniques for generating the change detection GT data for each of two consecutive frames: a difference metric (the top processing path of the pipeline 500) and an optical flow technique (the lower two processing paths of the pipeline 500).

The difference metric technique includes determining an intensity-based difference metric at diff block 515, where the intensity-based difference metric is based on each of two consecutive frames. The difference metric is input to a thresholding block 520, where an intensity-based thresholding mechanism can be applied to the difference metric to determine a per-pixel change. The thresholding block 520 output is input to a morphology block 525, where morphological operations are applied to enhance the thresholding output.

The optical flow metric technique includes applying an optical flow estimation model on each of two consecutive frames in both temporal directions. An optical flow estimation model is applied from frame n to frame n−1 at the optical flow block 530, and an optical flow estimation model is applied from frame n−1 to frame n at the optical flow block 532. In some examples, the optical flow estimation model estimates motion between the two frames. The bitemporal direction is used to include the occlusions in the GT data. Occlusions in the GT data can include situations where objects in a video frame are partially or fully blocked by other objects, making it challenging to accurately detect and track their motion, such as when a moving object in the foreground blocks the view of the background. For each temporal directed optical flow, per-pixel maximal absolute value between the X and Y components of the optical flow is determined. That is, the output from the optical flow block 530 is input to the abs block 535, where per-pixel absolute value between the X and Y components of the optical flow from frame n to frame n−1 is determined. At the max block 540, the per-pixel maximal absolute value between the X and Y components of the optical flow from frame n to frame n−1 is determined. The per-pixel maximal absolute value is input to a thresholding block 545, where an intensity-based thresholding mechanism can be applied to the per-pixel maximal absolute value to determine a per-pixel change. The thresholding block 545 output is input to a morphology block 550, where morphological operations are applied to enhance the thresholding output.

Similarly, the output from the optical flow block 532 is input to the abs block 537, where per-pixel absolute value between the X and Y components of the optical flow from frame n−1 to frame n is determined. At the max block 542, the per-pixel maximal absolute value between the X and Y components of the optical flow from frame n−1 to frame n is determined. The per-pixel maximal absolute value is input to a thresholding block 547, where an intensity-based thresholding mechanism can be applied to the per-pixel maximal absolute value to determine a per-pixel change. The thresholding block 547 output is input to a morphology block 552, where morphological operations are applied to enhance the thresholding output.

At the first fusion block 560, the output from the morphology block 550 and the output from the morphology block 552 are fused to generate a unified output. In some examples, the outputs are merged using an OR operation, which includes the union of the bi-temporal directions results of the optical flow techniques from the two lower processing paths of the pipeline 500, resulting in an optical flow output. At the second fusion block 570, the optical flow output and the difference metric output are combined to generate a unified output. In some examples, the outputs are merged using an OR operation, which includes the union of the optical flow output and the difference metric output.

In various examples, the difference metric technique and the optical flow technique are complementary since each technique addresses the limitations of the other technique. For example, the difference metric detects illumination differences between two consecutives frames while optical flow indicates changes that are related to motion. The optical flow includes a global approach that produces continuous results in large areas within the image, such that the optical flow can detect changes in local flat areas. The thresholding parameters can determine the sensitivity of the change detection model to changes between two consecutives frames.

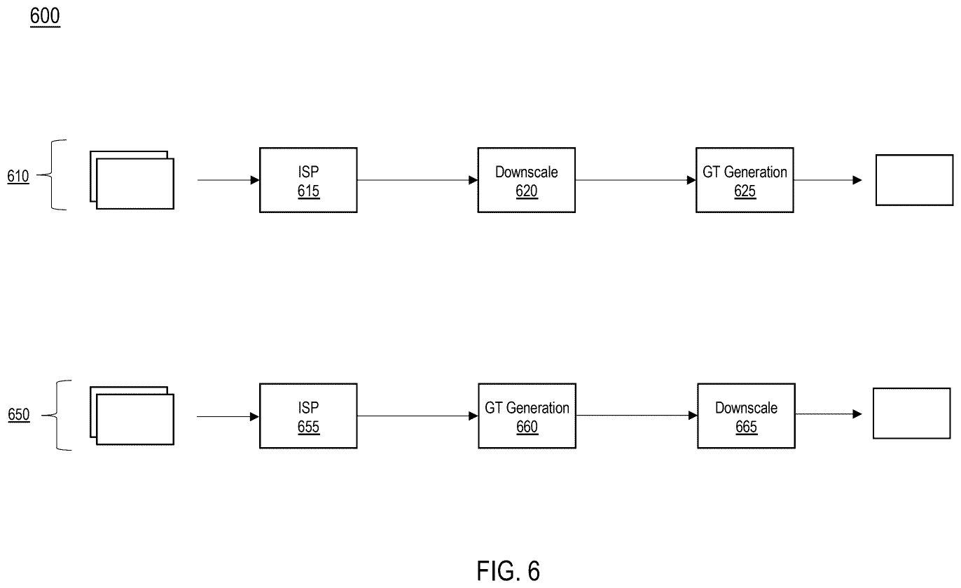

In general the change detection model presented here in works on downscaled low-resolution images. There are several methods for generating downscaled ground truth data. FIG. 6 illustrates a first process 610 for generating downscaled ground truth data and a second process 650 for generating ground truth data, in accordance with various embodiments. The first process 610 is to apply the GT generation flow on the downscaled input images. A second process 650 is to apply the GT generation flow on the high-resolution images and downscale the high-resolution results to the desired low-resolution.

In the first process 610, the neural network model is trained to detect changes that are visible in the downscaled video stream. The input images are processed at an ISP 615, and then downscaled at a downscale block 620. The downscaled video stream is used for GT data generation at the GT generation block 625. For example, for a downscale factor of 8, a threshold of ¼ pixel applied in the optical flow GT generation branch is equivalent to 2 pixels in the high-resolution video stream. Thus, the neural network will be less sensitive to changes that correspond to small movements in the high-resolution video stream.

In the second process 650, the neural network model is trained to detect both visible and invisible changes in the downscaled video stream. That is, the neural network model is trained to detect changes that are visible in the high-resolution video stream but invisible in the downscaled video stream. The input images are processed at an ISP 655, and the processed images are used for GT data generation at the GT generation block 660. The GT data is downscaled at a downscale block 665. For example, a threshold of ¼ pixel applied in the optical flow GT generation branch means that the neural network model is expected to detect changes in the low-resolution video stream that corresponds to movements equal to or above ¼ pixel in the high-resolution video stream, regardless of the downscale factor. The assumption here is that invisible changes in the low-resolution video stream will be ‘completed’ via semantic cues. For instance, consider a person waves hello with his hand in front of the camera. As the distance from the camera becomes larger, the hand movements become smaller and by nature of this kind of a movement, the movement of the shoulder is smaller than the movement of the hand. Though the relatively small movements are farther from the camera (e.g., the relatively smaller shoulder movements), it is with high probability that the visible movements of the hand in front of the camera imply also movements of the arm, shoulder, etc. For this semantic completion (‘inpainting’), the lumas of both consecutive video frames are concatenated to the input of the model. The lumas include semantic information of these frames. In various examples, the second process 650 for generating GT data results in more accurate change detection.

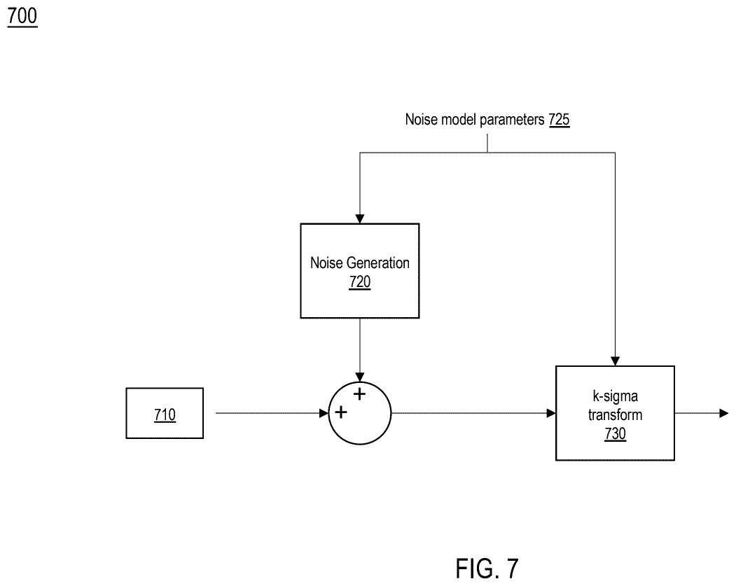

FIG. 7 is a block diagram illustrating training data noise augmentation, in accordance with various embodiments. In various examples, one challenge for accurate change detection by the change detection model is to distinguish between changes that correspond to temporal noise and changes that correspond to visual content. To distinguish between changes that correspond to temporal noise and changes that correspond to visual content, noise augmentation during training can be applied. As shown in FIG. 7, the noise model of the sensor that acquires the video stream can be characterized as noise model parameters 725. Based on the noise model parameters 725, synthetic noise can be generated by a noise generation block 720 in the training flow. The synthetic noise can be added to the raw images 710 of the dataset to generated noise-added images. The k-sigma transform 730 can then be applied to the noise-added images for use in the GT data generation.

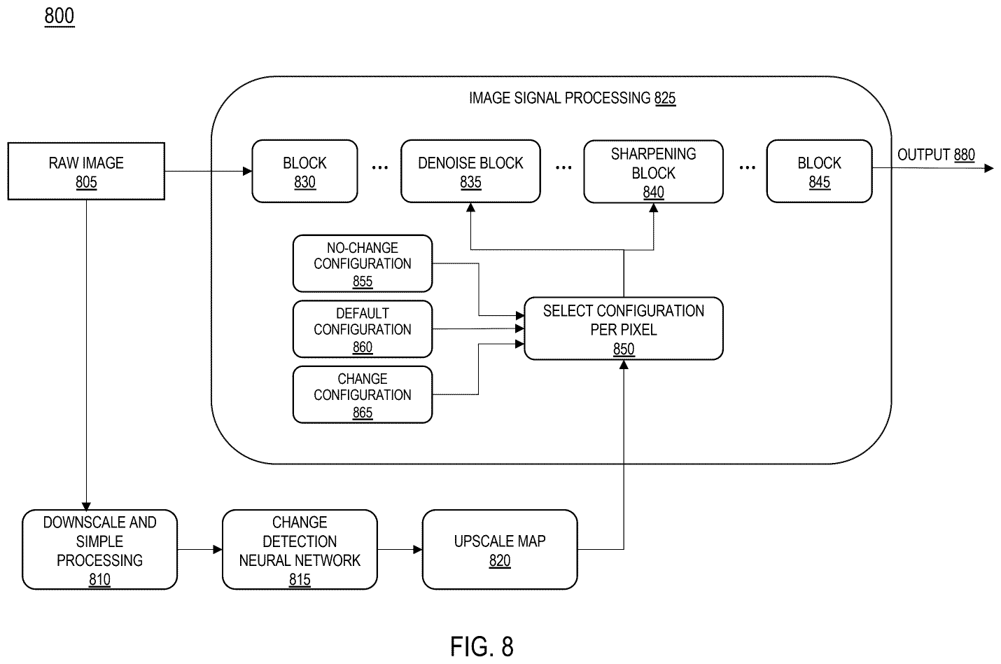

FIG. 8 is a block diagram of a change detection system 800 including an image signal processing (ISP) pipeline 825, in accordance with various embodiments. The ISP pipeline 825 includes a denoising block 835 and a sharpening block 840, each of which receives the change detection map to improve decision-making and thus image quality. The ISP pipeline 825 receives a raw, unprocessed image 805 from an image sensor. The raw image 805 is also received at a downscaling module 810, which downscales the raw image 805 and performs simple processing on the image, outputting a low resolution image.

The low resolution image from the downscaling module 810 is processed at a change detection neural network 815. The change detection neural network 815 can be a deep neural network such as a Convolutional Neural Network (CNN), as described in greater detail herein. The change detection neural network can be a semantic change detection model. Based on the low resolution image, the change detection neural network 815 predicts the static and dynamic pixels of the corresponding high resolution image 805. In particular, the change detection neural network 815 can be a CNN-based model that leverages both semantic information and change detection information in the low resolution image. Using the semantic and change detection information, the change detection neural network 815 makes spatially consistent decisions regarding the change detection map. In some embodiments, for each pixel in the low resolution image, the change detection neural network 815 predicts if the pixel is “static” or “dynamic”. The output from the change detection neural network 815 is an estimated low resolution change detection classification map.

The estimated low resolution change detection classification map output from change detection neural network 815 is input to an upscale map module 820. The upscale map module 820 upscales the estimated low resolution change detection classification map to the high resolution size of the image 805. The upscale map module 820 outputs a high resolution change detection map to the ISP 825. In some embodiments, the estimated low resolution change detection classification map output from the change detection neural network 815 is input to the ISP 825, and the estimated low resolution change detection classification map is upscaled to the high resolution size of the image 805 as part of the ISP 825.

The high resolution change detection map indicates the classification of each pixel in the high resolution image, where the classifications may be “static” (no change) or “dynamic” (changed). The pixel classification can then be used to determine how the respective pixel is processed in the ISP 825. In particular, pixels with high probability for motion will be processed by hardware blocks with a configuration and thresholds best suitable for moving objects, while pixels with a low probability for motion will be processed by hardware blocks with a configuration and thresholds best suitable for stationary objects. In some examples, when the change configuration 865 is selected in the hardware blocks, the hardware blocks will be more likely to classify the pixels as moving areas and treat them accordingly.

### Example Method for Change Detection

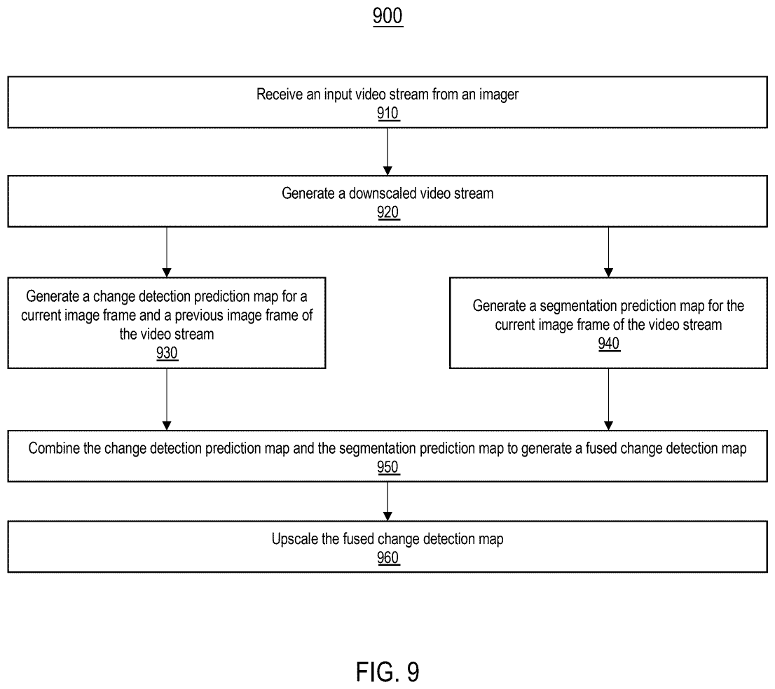

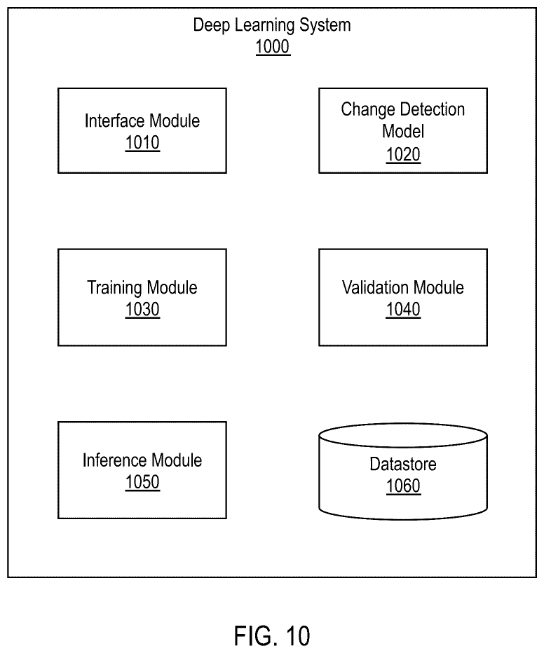

FIG. 9 is a flowchart showing a method 900 for change detection on a low-resolution video stream, in accordance with various embodiments. The method 900 may be performed by the system 800 of FIG. 8, and/or by the deep learning system 1000 in FIG. 10. Although the method 900 is described with reference to the flowchart illustrated in FIG. 9, other methods for change detection may alternatively be used. For example, the order of execution of the steps in FIG. 9 may be changed. As another example, some of the steps may be changed, eliminated, or combined.

At 910, an input video stream is received from an imager. The input video stream includes a current image frame and a previous image frame. The input video stream can be input to an ISP for pre-processing, as described, for example, with respect to FIGS. 1 and 2. At 920, a downscaled video stream is generated. In particular, the current image frame and the previous image frame can be downscaled for input to a change detection prediction model, and the current image frame can be downscaled for input to a segmentation module. The downscaling of the image frames can be different for input to the change detection model than for input to the segmentation module. In particular, for input to the change detection prediction model, downscaling includes removing large noise level variation using a k-sigma transform, determining a difference between the change detection low resolution current image and the low resolution previous image, determining a luma for each of the change detection low resolution current image and the low resolution previous image, wherein the luma provides semantic cues, and concatenating the difference and the luma to generate a change detection input for the neural network. For input to the segmentation module, downscaling can include white balance correction, color correction, and tone mapping.

At 930, a change detection prediction map for the current image frame is generated based on a downscaled current image frame and a downscaled previous image frame. As discussed above, the downscaled current image frame and a downscaled previous image frame can be downscaled specifically for input to a change detection prediction model.

At 940, a segmentation prediction map for the current image frame of the video stream is generated. The segmentation prediction map is generated based on a downscaled current image frame, and the downscaled current image frame input to the segmentation module can be downscaled specifically for input to the segmentation module.

At 950, the change detection prediction map and the segmentation prediction map are combined to generate a fused change detection map. As discussed above with respect to FIGS. 1-3, information provided in both the change detection prediction map and the segmentation prediction map can be used to generate the fused change detection map. In some examples, the change detection prediction map and the segmentation prediction map are combined by thresholding the intersection of union between the change detection prediction map and the segmentation prediction map.

At 960, the fused change detection map is upscaled. In various examples, the fused change detection map is upscaled to the resolution of the image frames in the input video stream, such as to the resolution of the raw input frames. The upscaled change detection map indicates a classification of each pixel in the high resolution current image, where the classification can be “static” (or “stationary”) or “dynamic” (“non-stationary”), where dynamic pixels are pixels that change from the previous image frame to the current image frame and static pixels are pixels that remain the same from the previous image frame to the current image frame. The upscaled change detection map can then be used for processing of each pixel in the high resolution current image, where pixels are processed based on their respective classification.

### Example DNN System for Change Detection

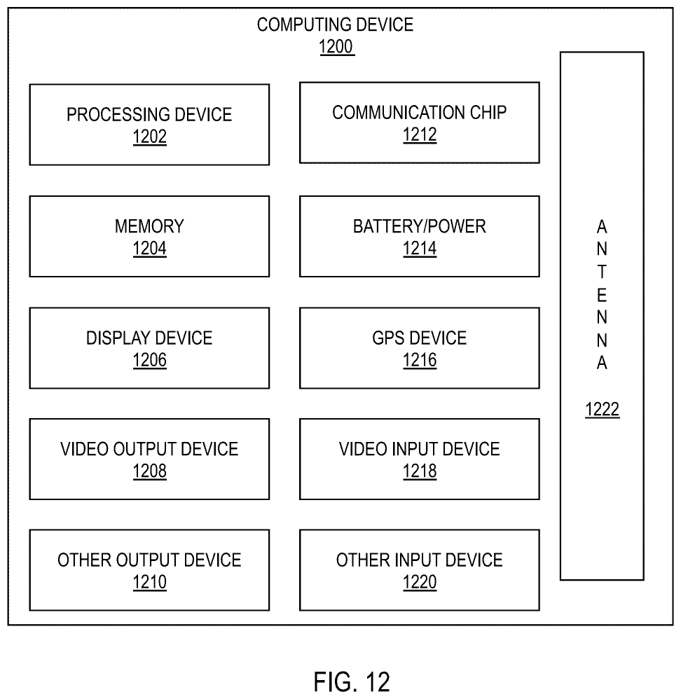

FIG. 10 is a block diagram of an example DNN system 1000, in accordance with various embodiments. The DNN system 1000 trains DNNs for various tasks, including change detection prediction between image frames of video streams. The DNN system 1000 includes an interface module 1010, a change detection model 1020, a training module 1030, a validation module 1040, an inference module 1050, and a datastore 1060. In other embodiments, alternative configurations, different or additional components may be included in the DNN system 1000. Further, functionality attributed to a component of the DNN system 1000 may be accomplished by a different component included in the DNN system 1000 or a different system. The DNN system 1000 or a component of the DNN system 1000 (e.g., the training module 1030 or inference module 1050) may include the computing device 1200 in FIG. 12.

The interface module 1010 facilitates communications of the DNN system 1000 with other systems. As an example, the interface module 1010 supports the DNN system 1000 to distribute trained DNNs to other systems, e.g., computing devices configured to apply DNNs to perform tasks. As another example, the interface module 1010 establishes communications between the DNN system 1000 with an external database to receive data that can be used to train DNNs or input into DNNs to perform tasks. In some embodiments, data received by the interface module 1010 may have a data structure, such as a matrix. In some embodiments, data received by the interface module 1010 may be an image, a series of images, and/or a video stream.

The change detection model 1020 predicts changes of pixels in consecutive images. In some examples, the change detection model 1020 performs change detection prediction on low resolution images. In general, the change detection model 1020 includes an encoder and a decoder. The change detection model 1020 receives downscaled image data (i.e., a low resolution version of the current image frame and a low resolution version of the previous image frame), and generates an estimated change detection map including a predicted change classification (e.g., static or non-static) for each pixel of the image. During training, the change detection model 1020 can use ground truth change detection prediction maps.

The training module 1030 trains DNNs by using training datasets. In some embodiments, a training dataset for training a DNN may include one or more images and/or videos, each of which may be a training sample. In some examples, the training module 1030 trains the change detection model 1020. The training module 1030 may receive real-world image data for processing with the change detection model 1020 as described herein. In some embodiments, the training module 1030 may input different data into different layers of the DNN. For every subsequent DNN layer, the input data may be less than the previous DNN layer. In some examples, the change detection model 1020 can be trained with ground truth change classification maps of images. In some examples, the difference between change detection model 1020 change detection map output and the corresponding groundtruth change detection classification map can be measured as the number of pixels in the corresponding maps that have different classifications from each other.

In some embodiments, a part of the training dataset may be used to initially train the DNN, and the rest of the training dataset may be held back as a validation subset used by the validation module 1040 to validate performance of a trained DNN. The portion of the training dataset not including the tuning subset and the validation subset may be used to train the DNN.

The training module 1030 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 1030 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different categories by training.

In the process of defining the architecture of the DNN, the training module 1030 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 1030 defines the architecture of the DNN, the training module 1030 inputs a training dataset into the DNN. The training dataset includes a plurality of training samples. An example of a training dataset includes a series of images of a video stream. Unlabeled, real-world video is input to the change detection model, and processed using the change detection model parameters of the DNN to produce two different model-generated outputs: a first time-forward model-generated output and a second time-reversed model-generated output. In the backward pass, the training module 1030 modifies the parameters inside the DNN (“internal parameters of the DNN”) to minimize the differences between the first model-generated output is and the second model-generated output. The internal parameters include weights of filters in the convolutional layers of the DNN. In some embodiments, the training module 1030 uses a cost function to minimize the differences.

The training module 1030 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 1030 finishes the predetermined number of epochs, the training module 1030 may stop updating the parameters in the DNN. The DNN having the updated parameters is referred to as a trained DNN.

The validation module 1040 verifies accuracy of trained DNNs. In some embodiments, the validation module 1040 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 1040 may determine an accuracy score measuring the precision, recall, or a combination of precision and recall of the DNN. The validation module 1040 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 1040 may compare the accuracy score with a threshold score. In an example where the validation module 1040 determines that the accuracy score of the augmented model is lower than the threshold score, the validation module 1040 instructs the training module 1030 to re-train the DNN. In one embodiment, the training module 1030 may iteratively re-train the DNN until the occurrence of a stopping condition, such as the accuracy measurement indication that the DNN may be sufficiently accurate, or a number of training rounds having taken place.

The inference module 1050 applies the trained or validated DNN to perform tasks. The inference module 1050 may run inference processes of a trained or validated DNN. In some examples, inference makes use of the forward pass to produce model-generated output for unlabeled real-world data. For instance, the inference module 1050 may input real-world data into the DNN and receive an output of the DNN. The output of the DNN may provide a solution to the task for which the DNN is trained for.

The inference module 1050 may aggregate the outputs of the DNN to generate a final result of the inference process. In some embodiments, the inference module 1050 may distribute the DNN to other systems, e.g., computing devices in communication with the DNN system 1000, for the other systems to apply the DNN to perform the tasks. The distribution of the DNN may be done through the interface module 1010. In some embodiments, the DNN system 1000 may be implemented in a server, such as a cloud server, an edge service, and so on. The computing devices may be connected to the DNN system 1000 through a network. Examples of the computing devices include edge devices.

The datastore 1060 stores data received, generated, used, or otherwise associated with the DNN system 1000. For example, the datastore 1060 stores video processed by the change detection model 1020 or used by the training module 1030, validation module 1040, and the inference module 1050. The datastore 1060 may also store other data generated by the training module 1030 and validation module 1040, such as the hyperparameters for training DNNs, internal parameters of trained DNNs (e.g., values of tunable parameters of activation functions, such as Fractional Adaptive Linear Units (FALUs)), etc. In the embodiment of FIG. 10, the datastore 1060 is a component of the DNN system 1000. In other embodiments, the datastore 1060 may be external to the DNN system 1000 and communicate with the DNN system 1000 through a network.

In general, an uncalibrated or badly calibrated change detection model would fail to discriminate between stationary and non-stationary regions in the frames of the current input frame and the previous input frame. Similarly, an uncalibrated or badly calibrated change detection model would fail to discriminate between similar and dissimilar regions in the image frames.

For change detection model training, the input can include an input image frame and a labeled groundtruth change detection model-processed image. In various examples, the input image frame is received at a change detection module such as the change detection model of image processing systems 100, 200, or 400, or the change detection model 1020. In other examples, the input image frame can be received at the training module 1030 or the inference module 1050 of FIG. 10. The imager can be a camera, such as a video camera. The input image frame can be a still image from the video camera feed. The input image frame can include a matrix of pixels, each pixel having a color, lightness, and/or other parameter. The input image frame can be downscaled and processed by a pre-processing block. Various steps can be repeated to further adjust the change detection model parameters. In some examples, the training can be repeated with a new input image frame and groundtruth change detection model-processed image.

### Example CNN System for Change Detection

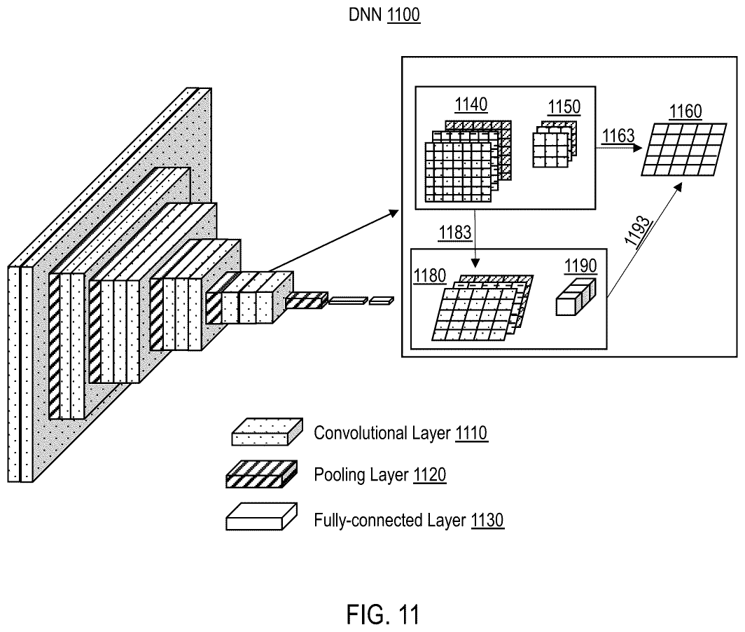

FIG. 11 illustrates an example DNN 1100, in accordance with various embodiments. For purpose of illustration, the DNN 1100 in FIG. 11 is a CNN. In other embodiments, the DNN 1100 may be other types of DNNs. The DNN 1100 is trained to receive images and output classifications of objects in the images. In the embodiments of FIG. 11, the DNN 1100 receives an input image 1105 that includes objects. The DNN 1100 includes a sequence of layers comprising a plurality of convolutional layers 1110 (individually referred to as “convolutional layer 1110”), a plurality of pooling layers 1120 (individually referred to as “pooling layer 1120”), and a plurality of fully connected layers 1130 (individually referred to as “fully connected layer 1130”). In other embodiments, the DNN 1100 may include fewer, more, or different layers. In an inference of the DNN 1100, the layers of the DNN 1100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 1110 summarize the presence of features in the input image 1105. The convolutional layers 1110 function as feature extractors. The first layer of the DNN 1100 is a convolutional layer 1110. In an example, a convolutional layer 1110 performs a convolution on an input tensor 1140 (also referred to as IFM 1140) and a filter 1150. As shown in FIG. 11, the IFM 1140 is represented by a 7×7×3 three-dimensional (3D) matrix. The IFM 1140 includes 3 input channels, each of which is represented by a 7×7 two-dimensional (2D) matrix. The 7×7 2D matrix includes 7 input elements (also referred to as input points) in each row and seven input elements in each column. The filter 1150 is represented by a 3×3×3 3D matrix. The filter 1150 includes 3 kernels, each of which may correspond to a different input channel of the IFM 1140. A kernel is a 2D matrix of weights, where the weights are arranged in columns and rows. A kernel can be smaller than the IFM. In the embodiments of FIG. 11, each kernel is represented by a 3×3 2D matrix. The 3×3 kernel includes 3 weights in each row and three weights in each column. Weights can be initialized and updated by backpropagation using gradient descent. The magnitudes of the weights can indicate importance of the filter 1150 in extracting features from the IFM 1140.

The convolution includes MAC operations with the input elements in the IFM 1140 and the weights in the filter 1150. The convolution may be a standard convolution 1163 or a depthwise convolution 1183. In the standard convolution 1163, the whole filter 1150 slides across the IFM 1140. All the input channels are combined to produce an output tensor 1160 (also referred to as output feature map (OFM) 1160). The OFM 1160 is represented by a 5×5 2D matrix. The 5×5 2D matrix includes 5 output elements (also referred to as output points) in each row and five output elements in each column. For purpose of illustration, the standard convolution includes one filter in the embodiments of FIG. 11. In embodiments where there are multiple filters, the standard convolution may produce multiple output channels in the OFM 1160.

The multiplication applied between a kernel-sized patch of the IFM 1140 and a kernel may be a dot product. A dot product is the elementwise multiplication between the kernel-sized patch of the IFM 1140 and the corresponding kernel, which is then summed, always resulting in a single value. Because it results in a single value, the operation is often referred to as the “scalar product.” Using a kernel smaller than the IFM 1140 is intentional as it allows the same kernel (set of weights) to be multiplied by the IFM 1140 multiple times at different points on the IFM 1140. Specifically, the kernel is applied systematically to each overlapping part or kernel-sized patch of the IFM 1140, left to right, top to bottom. The result from multiplying the kernel with the IFM 1140 one time is a single value. As the kernel is applied multiple times to the IFM 1140, the multiplication result is a 2D matrix of output elements. As such, the 2D output matrix (i.e., the OFM 1160) from the standard convolution 1163 is referred to as an OFM.

In the depthwise convolution 1183, the input channels are not combined. Rather, MAC operations are performed on an individual input channel and an individual kernel and produce an output channel. As shown in FIG. 11, the depthwise convolution 1183 produces a depthwise output tensor 1180. The depthwise output tensor 1180 is represented by a 5×5×3 3D matrix. The depthwise output tensor 1180 includes 3 output channels, each of which is represented by a 5×5 2D matrix. The 5×5 2D matrix includes 5 output elements in each row and five output elements in each column. Each output channel is a result of MAC operations of an input channel of the IFM 1140 and a kernel of the filter 1150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 1193 is then performed on the depthwise output tensor 1180 and a 1×1×3 tensor 1190 to produce the OFM 1160.

The OFM 1160 is then passed to the next layer in the sequence. In some embodiments, the OFM 1160 is passed through an activation function. An example activation function is the rectified linear activation function (ReLU). ReLU is a calculation that returns the value provided as input directly, or the value zero if the input is zero or less. The convolutional layer 1110 may receive several images as input and calculate the convolution of each of them with each of the kernels. This process can be repeated several times. For instance, the OFM 1160 is passed to the subsequent convolutional layer 1110 (i.e., the convolutional layer 1110 following the convolutional layer 1110 generating the OFM 1160 in the sequence). The subsequent convolutional layers 1110 perform a convolution on the OFM 1160 with new kernels and generates a new feature map. The new feature map may also be normalized and resized. The new feature map can be kernelled again by a further subsequent convolutional layer 1110, and so on.

In some embodiments, a convolutional layer 1110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 1110). The convolutional layers 1110 may perform various types of convolutions, such as 2-dimensional convolution, dilated or atrous convolution, spatial separable convolution, depthwise separable convolution, transposed convolution, and so on. The DNN 1100 includes 16 convolutional layers 1110. In other embodiments, the DNN 1100 may include a different number of convolutional layers.

The pooling layers 1120 down-sample feature maps generated by the convolutional layers, e.g., by summarizing the presence of features in the patches of the feature maps. A pooling layer 1120 is placed between two convolution layers 1110: a preceding convolutional layer 1110 (the convolution layer 1110 preceding the pooling layer 1120 in the sequence of layers) and a subsequent convolutional layer 1110 (the convolution layer 1110 subsequent to the pooling layer 1120 in the sequence of layers). In some embodiments, a pooling layer 1120 is added after a convolutional layer 1110, e.g., after an activation function (e.g., ReLU, etc.) has been applied to the OFM 1160.

A pooling layer 1120 receives feature maps generated by the preceding convolution layer 1110 and applies a pooling operation to the feature maps. The pooling operation reduces the size of the feature maps while preserving their important characteristics. Accordingly, the pooling operation improves the efficiency of the DNN and avoids over-learning. The pooling layers 1120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 1120 applied to a feature map of 6×6 results in an output pooled feature map of 3×3. The output of the pooling layer 1120 is inputted into the subsequent convolution layer 1110 for further feature extraction. In some embodiments, the pooling layer 1120 operates upon each feature map separately to create a new set of the same number of pooled feature maps.

The fully connected layers 1130 are the last layers of the DNN. The fully connected layers 1130 may be convolutional or not. The fully connected layers 1130 receive an input operand. The input operand defines the output of the convolutional layers 1110 and pooling layers 1120 and includes the values of the last feature map generated by the last pooling layer 1120 in the sequence. The fully connected layers 1130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 1130 by using a logistic function (binary classification) or a softmax function (multi-class classification) as an activation function.

In some embodiments, the fully connected layers 1130 classify the input image 1105 and return an operand of size N, where N is the number of classes in the image classification problem. Each element of the operand indicates the probability for the input image 1105 to belong to a class. To calculate the probabilities, the fully connected layers 1130 multiply each input element by weight, make the sum, and then apply an activation function (e.g., logistic if N=2, softmax if N>2). This is equivalent to multiplying the input operand by the matrix containing the weights. In other embodiments where the input image 1105 includes different objects or a different number of objects, the individual values can be different.

### Example Computing Device

FIG. 12 is a block diagram of an example computing device 1200, in accordance with various embodiments. In some embodiments, the computing device 1200 may be used for at least part of the deep learning system 1000 in FIG. 10. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include a video input device 1218 or a video output device 1208, but may include video input or output device interface circuitry (e.g., connectors and supporting circuitry) to which a video input device 1218 or video output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable for occupancy mapping or collision detection, e.g., the method 500 described above in conjunction with FIG. 5 or some operations performed by the DNN system 1000 in FIG. 10. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include a video output device 1208 (or corresponding interface circuitry, as discussed above). The video output device 1208 may include any device that generates an audible indicator, such as speakers, headsets, or earbuds, for example.

The computing device 1200 may include a video input device 1218 (or corresponding interface circuitry, as discussed above). The video input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include a video codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Selected Examples

The following paragraphs provide various examples of the embodiments disclosed herein.

Example 1 provides a computer-implemented method, including receiving an input video stream from an image sensor, where the input video stream includes a current image frame and a previous image frame, where the current image frame and the previous image frame are raw, high resolution images; downscaling the current image frame and the previous image frame to generate a low resolution current image and a low resolution previous image; processing the low resolution current image and the low resolution previous image at a neural network to generate a first change detection prediction map; processing the low resolution current image to generate a segmentation prediction map; generating a fused change detection prediction map based on the first change detection prediction map and the segmentation prediction map; upscaling the fused change detection prediction map to a high resolution change detection map, where the high resolution change detection map indicates a classification of each pixel in the high resolution image; and processing each pixel of the high resolution image based on the respective classification.

Example 2 provides the computer-implemented method of example 1, where downscaling the current image frame and the previous image frame includes generating a change detection low resolution current image and a segmentation low resolution current image, where the change detection low resolution current image is different from the segmentation low resolution current image.

Example 3 provides the computer-implemented method of example 2, where generating the change detection low resolution current image includes removing large noise level variation using a k-sigma transform.

Example 4 provides the computer-implemented method of example 3, where generating the change detection low resolution current image and the low resolution previous image includes determining a difference between the change detection low resolution current image and the low resolution previous image, determining a luma for each of the change detection low resolution current image and the low resolution previous image, where the luma provides semantic cues, and concatenating the difference and the luma to generate a change detection input for the neural network.

Example 5 provides the computer-implemented method of any one of examples 1-4, where the neural network is a convolutional neural network having a U-Net architecture including an encoder and a decoder.

Example 6 provides the computer-implemented method according to example 5, where the encoder includes convolutional layers and max pooling layers, and where processing the low resolution image at the neural network includes incorporating semantic knowledge into change detection estimation at the max pooling layers.

Example 7 provides the computer-implemented method according to example 6, where the decoder includes up-convolution operations and convolutional layers and where processing the low resolution image at the neural network includes combining extracted features to make change detection predictions.

Example 8 provides the computer-implemented method of any one of examples 1-7, where generating the fused change detection prediction map includes thresholding the intersection of union of the first change detection prediction map and the segmentation prediction map to identify stationary portions of the current image frame and non-stationary portions of the current image frame.

Example 9 provides one or more non-transitory computer-readable media storing instructions executable to perform operations, the operations including receiving an input video stream from an image sensor, where the input video stream includes a current image frame and a previous image frame, where the current image frame and the previous image frame are raw, high resolution images; downscaling the current image frame and the previous image frame to generate a low resolution current image and a low resolution previous image; processing the low resolution current image and the low resolution previous image at a neural network to generate a first change detection prediction map; processing the low resolution current image to generate a segmentation prediction map; generating a fused change detection prediction map based on the first change detection prediction map and the segmentation prediction map; upscaling the fused change detection prediction map to a high resolution change detection map, where the high resolution change detection map indicates a classification of each pixel in the high resolution image; and processing each pixel of the high resolution image based on the respective classification.

Example 10 provides the one or more non-transitory computer-readable media according to example 9, where downscaling the current image frame and the previous image frame includes generating a change detection low resolution current image and a segmentation low resolution current image, where the change detection low resolution current image is different from the segmentation low resolution current image.

Example 11 provides the one or more non-transitory computer-readable media according to example 10, where generating the change detection low resolution current image includes removing large noise level variation using a k-sigma transform.

Example 12 provides the one or more non-transitory computer-readable media according to example 11, where generating the change detection low resolution current image and the low resolution previous image includes determining a difference between the change detection low resolution current image and the low resolution previous image, determining a luma for each of the change detection low resolution current image and the low resolution previous image, where the luma provides semantic cues, and concatenating the difference and the luma to generate a change detection input for the neural network.

Example 13 provides the one or more non-transitory computer-readable media according to any one of examples 9-12, where the neural network is a convolutional neural network having a U-Net architecture including an encoder and a decoder.

Example 14 provides one or more non-transitory computer-readable media according to example 13, where the encoder includes convolutional layers and max pooling layers, and where processing the low resolution image at the neural network includes incorporating semantic knowledge into change detection estimation at the max pooling layers.

Example 15 provides the one or more non-transitory computer-readable media according to example 14, where the decoder includes up-convolution operations and convolutional layers and where processing the low resolution image at the neural network includes combining extracted features to make change detection predictions.

Example 16 provides the one or more non-transitory computer-readable media according to any one of examples 9-15, where generating the fused change detection prediction map includes thresholding the intersection of union of the first change detection prediction map and the segmentation prediction map to identify stationary portions of the current image frame and non-stationary portions of the current image frame.

Example 17 provides an apparatus, including a computer processor for executing computer program instructions; and a non-transitory computer-readable memory storing computer program instructions executable by the computer processor to perform operations including receiving an input video stream from an image sensor, where the input video stream includes a current image frame and a previous image frame, where the current image frame and the previous image frame are raw, high resolution images; downscaling the current image frame and the previous image frame to generate a low resolution current image and a low resolution previous image; processing the low resolution current image and the low resolution previous image at a neural network to generate a first change detection prediction map; processing the low resolution current image to generate a segmentation prediction map; generating a fused change detection prediction map based on the first change detection prediction map and the segmentation prediction map; upscaling the fused change detection prediction map to a high resolution change detection map, where the high resolution change detection map indicates a classification of each pixel in the high resolution image; and processing each pixel of the high resolution image based on the respective classification.

Example 18 provides the apparatus according to example 17, where the neural network is a convolutional neural network having a U-Net architecture including an encoder and a decoder.

Example 19 provides the apparatus according to example 18, where the encoder includes convolutional layers and max pooling layers, and where processing the low resolution image at the neural network includes incorporating semantic knowledge into change detection estimation at the max pooling layers.

Example 20 provides the apparatus according to example 19, where the decoder includes up-convolution operations and convolutional layers and where processing the low resolution image at the neural network includes combining extracted features to make change detection predictions.

Example 21 provides the apparatus according to example 17, where downscaling the current image frame and the previous image frame includes generating a change detection low resolution current image and a segmentation low resolution current image, where the change detection low resolution current image is different from the segmentation low resolution current image.

Example 22 provides the apparatus according to example 21, where generating the change detection low resolution current image includes removing large noise level variation using a k-sigma transform.

Example 23 provides the apparatus according to example 22, where generating the change detection low resolution current image and the low resolution previous image includes determining a difference between the change detection low resolution current image and the low resolution previous image, determining a luma for each of the change detection low resolution current image and the low resolution previous image, where the luma provides semantic cues, and concatenating the difference and the luma to generate a change detection input for the neural network.

Example 24 provides the apparatus according to any one of examples 17-23, where generating the fused change detection prediction map includes thresholding the intersection of union of the first change detection prediction map and the segmentation prediction map to identify stationary portions of the current image frame and non-stationary portions of the current image frame.

Example 25 provides the computer-implemented method of any one of examples 1-7, further comprising providing noise augmentation during training, including adding synthetic noise to raw images of a training dataset.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving an input video stream from an image sensor, wherein the input video stream includes a current image frame and a previous image frame, wherein the current image frame and the previous image frame are raw, high resolution images;
downscaling the current image frame and the previous image frame to generate a low resolution current image and a low resolution previous image;
processing the low resolution current image and the low resolution previous image at a neural network to generate a first change detection prediction map;
processing the low resolution current image to generate a segmentation prediction map;
generating a fused change detection prediction map based on the first change detection prediction map and the segmentation prediction map;
upscaling the fused change detection prediction map to a high resolution change detection map, wherein the high resolution change detection map indicates a classification of each pixel in the current image frame; and
processing each pixel of the current image frame based on the respective classification.

2. The computer-implemented method of claim 1, wherein downscaling the current image frame and the previous image frame includes generating a change detection low resolution current image and a segmentation low resolution current image, wherein the change detection low resolution current image is different from the segmentation low resolution current image.

3. The computer-implemented method of claim 2, wherein generating the change detection low resolution current image includes removing large noise level variation using a k-sigma transform.

4. The computer-implemented method of claim 3, wherein generating the change detection low resolution current image and the low resolution previous image includes:
determining a difference between the change detection low resolution current image and the low resolution previous image,
determining a luma for each of the change detection low resolution current image and the low resolution previous image, wherein the luma provides semantic cues, and
concatenating the difference and the luma to generate a change detection input for the neural network.

5. The computer-implemented method of claim 1, wherein the neural network is a convolutional neural network having a U-Net architecture including an encoder and a decoder.

6. The computer-implemented method according to claim 5, wherein the encoder includes convolutional layers and max pooling layers, and wherein processing the low resolution current image at the neural network includes incorporating semantic knowledge into change detection estimation at the max pooling layers.

7. The computer-implemented method according to claim 6, wherein the decoder includes up-convolution operations and convolutional layers and wherein processing the low resolution current image at the neural network includes combining extracted features to make change detection predictions.

8. The computer-implemented method of claim 1, wherein generating the fused change detection prediction map includes thresholding an intersection of union of the first change detection prediction map and the segmentation prediction map to identify stationary portions of the current image frame and non-stationary portions of the current image frame.

9. One or more non-transitory computer-readable media storing instructions executable to perform operations, the operations comprising:
receiving an input video stream from an image sensor, wherein the input video stream includes a current image frame and a previous image frame, wherein the current image frame and the previous image frame are raw, high resolution images;
downscaling the current image frame and the previous image frame to generate a low resolution current image and a low resolution previous image;
processing the low resolution current image and the low resolution previous image at a neural network to generate a first change detection prediction map;
processing the low resolution current image to generate a segmentation prediction map;
generating a fused change detection prediction map based on the first change detection prediction map and the segmentation prediction map;
upscaling the fused change detection prediction map to a high resolution change detection map, wherein the high resolution change detection map indicates a classification of each pixel in the current image frame; and
processing each pixel of the current image frame based on the respective classification.

10. The one or more non-transitory computer-readable media according to claim 9, wherein downscaling the current image frame and the previous image frame includes generating a change detection low resolution current image and a segmentation low resolution current image, wherein the change detection low resolution current image is different from the segmentation low resolution current image.

11. The one or more non-transitory computer-readable media according to claim 10, wherein generating the change detection low resolution current image includes removing large noise level variation using a k-sigma transform.

12. The one or more non-transitory computer-readable media according to claim 11, wherein generating the change detection low resolution current image and the low resolution previous image includes:
determining a difference between the change detection low resolution current image and the low resolution previous image,
determining a luma for each of the change detection low resolution current image and the low resolution previous image, wherein the luma provides semantic cues, and
concatenating the difference and the luma to generate a change detection input for the neural network.

13. The one or more non-transitory computer-readable media according to claim 9, wherein the neural network is a convolutional neural network having a U-Net architecture including an encoder and a decoder.

14. The one or more non-transitory computer-readable media according to claim 13, wherein the encoder includes convolutional layers and max pooling layers, and wherein processing the low resolution current image at the neural network includes incorporating semantic knowledge into change detection estimation at the max pooling layers.

15. The one or more non-transitory computer-readable media according to claim 14, wherein the decoder includes up-convolution operations and convolutional layers and wherein processing the low resolution current image at the neural network includes combining extracted features to make change detection predictions.

16. The one or more non-transitory computer-readable media according to claim 9, wherein generating the fused change detection prediction map includes thresholding an intersection of union of the first change detection prediction map and the segmentation prediction map to identify stationary portions of the current image frame and non-stationary portions of the current image frame.

17. An apparatus, comprising:
a computer processor for executing computer program instructions; and
a non-transitory computer-readable memory storing computer program instructions executable by the computer processor to perform operations comprising:
receiving an input video stream from an image sensor, wherein the input video stream includes a current image frame and a previous image frame, wherein the current image frame and the previous image frame are raw, high resolution images;
downscaling the current image frame and the previous image frame to generate a low resolution current image and a low resolution previous image;
processing the low resolution current image and the low resolution previous image at a neural network to generate a first change detection prediction map;
processing the low resolution current image to generate a segmentation prediction map;
generating a fused change detection prediction map based on the first change detection prediction map and the segmentation prediction map;
upscaling the fused change detection prediction map to a high resolution change detection map, wherein the high resolution change detection map indicates a classification of each pixel in the current image frame; and
processing each pixel of the current image frame based on the respective classification.

18. The apparatus according to claim 17, wherein the neural network is a convolutional neural network having a U-Net architecture including an encoder and a decoder.

19. The apparatus according to claim 18, wherein the encoder includes convolutional layers and max pooling layers, and wherein processing the low resolution current image at the neural network includes incorporating semantic knowledge into change detection estimation at the max pooling layers.

20. The apparatus according to claim 19, wherein the decoder includes up-convolution operations and convolutional layers and wherein processing the low resolution current image at the neural network includes combining extracted features to make change detection predictions.
